(19) United States
(12) Patent Application Publication
(10) Pub. No.: US 2011/0318666 A1
(43) Pub. Date: Dec. 29, 2011

(54) FUEL CELL STACK ASSEMBLY SEAL

(76) Inventors: Timothy W. Patterson, Jr., West Hartford, CT (US); Tommy Skiba, East Hartford, CT (US); David D. Jayne, Washington, IL (US)

(21) Appl. No.: 13/126,054

(22) PCT Filed: Oct. 22, 2008
(86) PCT No.: PCT/US08/80738

§ 371 Date: Apr. 26, 2011

(51) Int. Cl. H01M 8/04; H01M 8/00; H01M 8/10

(52) U.S. Cl. 429/480; 429/514; 429/535

(57) ABSTRACT

A fuel cell is disclosed that includes an electrode assembly arranged between a cathode and an anode. The anode and cathode have lateral surfaces adjoining lateral surface of the electrode assembly and respectively include fuel and oxidant flow fields. Interfacial seals are not arranged between the lateral surfaces. Instead, a sealant is applied to the anode, the cathode and the electrode assembly to fluidly separate the fuel and oxidant flow fields. In one example, the adjoining lateral surfaces are in abutting engagement with one another. The sealant is applied in a liquid, uncured state to perimeter surfaces of the electrode assembly, the anode and the cathode that surround the lateral surfaces.

### BACKGROUND

This disclosure relates to sealing the components of a fuel cell stack assembly, which includes an anode, a cathode and an electrode assembly.

Traditional fuel cell stack assembly designs use interfacial seals between the components of the cell stack assembly. Each cell includes an anode, a cathode and an electrode assembly. A fuel cell typically includes dozens or more cells arranged to provide the cell stack assembly. As a result, up to a hundred or more interfacial seals are placed one-at-a-time on each component, which takes a considerable time to arrange within the cell stack assembly. Moreover, due to the large number of interfacial seals, the likelihood of a leak occurring past the seals is increased.

In particular, the interfacial seals are arranged between the lateral sides of the anode, the cathode and the electrode assembly to prevent the fuel and oxidant from escaping their respective flow fields thereby bypassing the electrode assembly and intermixing undesirably with one another. The electrode assembly also includes interfacial seals between the faces of its components, which includes a membrane electrode assembly arranged between gas diffusion layers. The electrode assembly typically includes polyethylene sheets that are arranged between the electrode assembly components and heated under pressure to seal the components to one another.

A sealing arrangement for a cell stack assembly has been disclosed for sealing the coolant passages from the rest of the cell stack assembly. However, the interfacial seals between the various cell stack components are still used. The arrangement includes foam rubber gaskets arranged about protrusions extending from the cooler plate. Silicone rubber seals on the cell stack assembly manifolds engage the foam rubber gaskets to isolate the coolant from the rest of the cell stack assembly.

What is needed is a reliable seal design and method that reduces the cell stack assembly complexity and production time.

### SUMMARY

A fuel cell is disclosed that includes an electrode assembly arranged between a cathode and an anode. The anode and cathode have lateral surfaces adjoining lateral surface of the electrode assembly and respectively include fuel and oxidant flow fields. Interfacial seals are not arranged between the lateral surfaces. Instead, a sealant is applied to the anode, the cathode and the electrode assembly to fluidly separate the fuel and oxidant flow fields. In one example, the adjoining lateral surfaces are in abutting engagement with one another. The sealant is applied in a liquid, uncured state to perimeter surfaces of the electrode assembly, the anode and the cathode that surround the lateral surfaces.

Accordingly, the disclosed sealing arrangement provides a reliable seal design and method that reduces the cell stack assembly complexity and production time by eliminating the prior art interfacial seals.

### BRIEF DESCRIPTION OF THE DRAWINGS

The disclosure can be further understood by reference to the following detailed description when considered in connection with the accompanying drawings wherein:

FIG. 1 is a highly schematic view of an example fuel cell.

FIG. 2 is a side perspective view of a portion of an example cell stack assembly.

FIG. 3 is a side perspective view of the cell stack assembly shown in FIG. 2 with a sealant applied over perimeter surfaces of the cell stack assembly components.

FIG. 4 is an end view of the cell stack assembly illustrating manifolds arranged on four sides of the cell stack assembly.

FIG. 5 is an enlarged cross-sectional view of an end of a manifold embedded in the sealant.

FIG. 6 is a cross-sectional view of two cell stack assembly components sealed relative to one another with sealant.

FIG. 7 is a cross-sectional view of an arrangement of offset cell stack assembly components sealed relative to one another with the sealant.

FIG. 8 is a partial cross-sectional view of an electrode assembly sealed relative to one another with the sealant.

FIG. 9 is a side perspective view of a cell stack assembly encapsulated in sealant.

FIG. 10 is a side perspective view of the cell stack assembly shown in FIG. 9 subsequent to machining.

### DETAILED DESCRIPTION

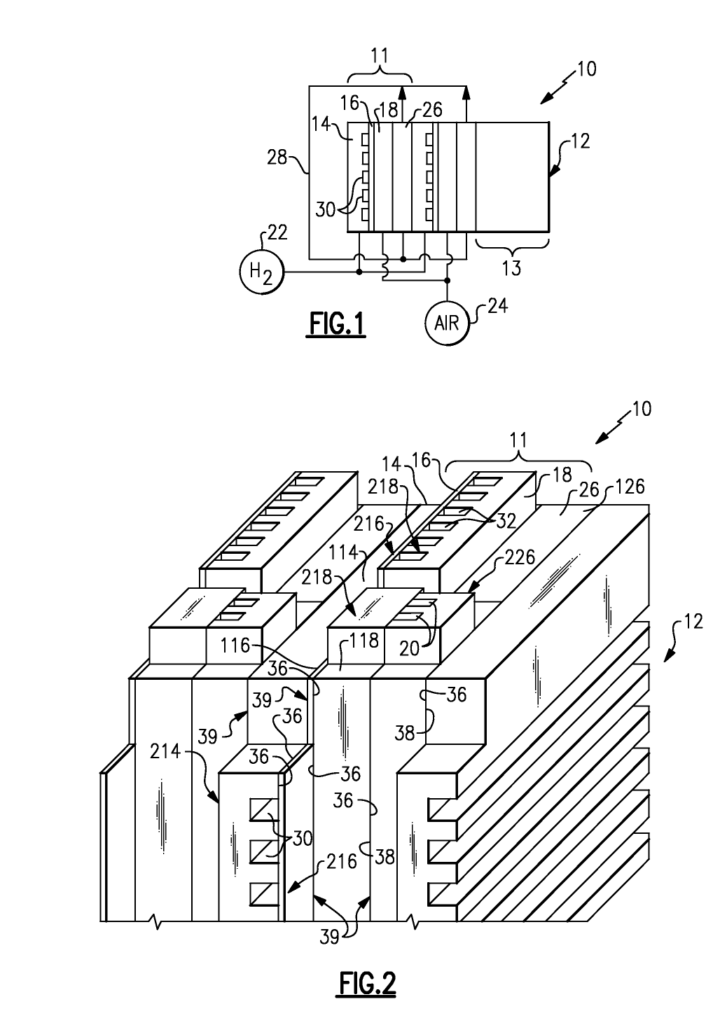

A highly schematic view of a fuel cell 10 is shown in FIG. 1. The fuel cell 10 includes multiple cells 11 that provide a cell stack assembly 12. Each cell 11 includes an electrode assembly 16 arranged between an anode 14 and a cathode 18. Additional cells 13 are schematically shown as part of the cell stack assembly 12.

Each cell 11 typically includes a coolant flow field 20 that may be provided by a separate structure or integrated into one of the components of the cell 11. Each anode 14 includes a fuel flow field 30 that is in fluid communication with a fuel source 22. The fuel source 22 is hydrogen, in one example. The cathodes 18 provide an oxidant or reactant flow field 32 (best shown in FIG. 2) that is in fluid communication with an oxidant or reactant source 24. In one example, the oxidant is provided by air. The coolant flow field 20 may include a coolant loop 28 for circulating coolant within the cell stack assembly 12 to maintain the fuel cell 10 at or below a desired operating temperature.

Referring to FIG. 2, the anode 14, the electrode assembly 16 and the cathode 18 include lateral surfaces 36 that adjoin one another to provide joints 39. Hydrogen from the fuel flow field 30 must be prevented from mixing with air from the oxidant flow field 32, such as by bypassing the electrode assembly 16. To this end, interfacial seals have been used in the prior art between the anode 14, electrode assembly 16 and cathode 18 to seal the lateral surfaces 36 relative to one another. In one example, a coolant plate 26 is used between the anode 14 and cathode 18. The coolant plate 26 provides the coolant flow field 20.

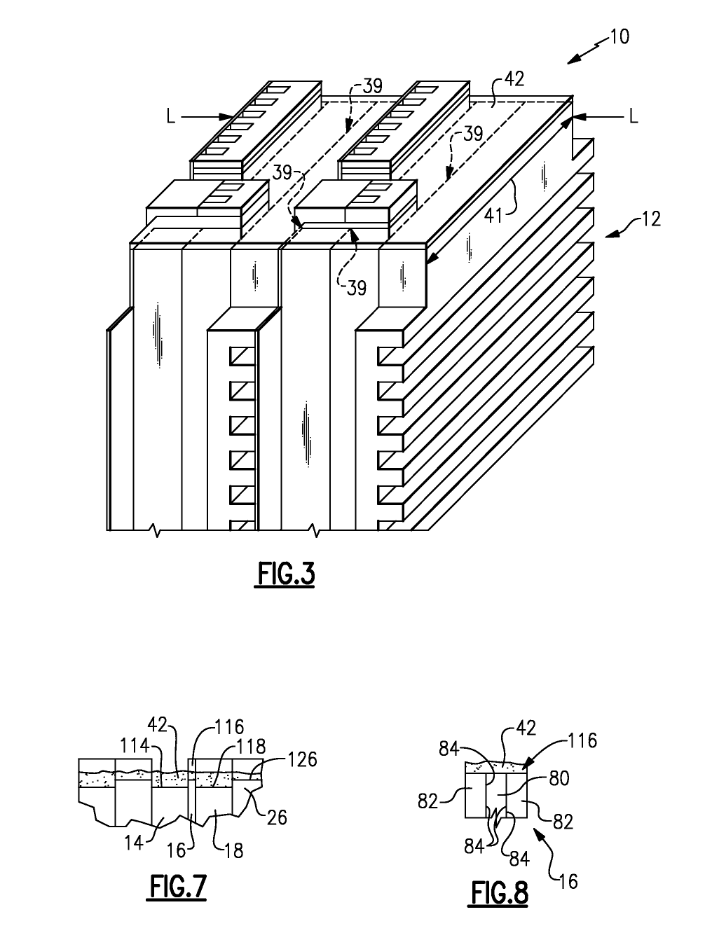

In the example shown in FIGS. 2 and 3, the lateral surfaces 36 of the anode 14, electrode assembly 16 and cathode 18 are arranged adjacent to one another without the use of any interfacial seals or gaskets between the lateral surfaces 36 to seal the cell stack assembly components relative to one another. Coolant lateral surfaces 38 are also arranged adjacent to the lateral surfaces 36 of the anode 14 and cathode 18 without the use of any interfacial seals. In the example shown, the lateral surfaces 36 and coolant lateral surfaces 38 are in abutting engagement with one another, providing joints 39. The anode 14, electrode assembly 16, cathode 18 and coolant plate 26 respectively include perimeter surfaces 114, 116, 118, 126 transverse to and arranged about the lateral surfaces 36 and/or coolant lateral surfaces 38.

In the example shown, the anode 14, electrode assembly 16, cathode 18 and coolant plate 26 each respectively include protrusions 214, 216, 218, 226 that extend from their respective perimeter surfaces 114, 116, 118, 126. The anode protrusion 214, cathode protrusion 218 and coolant protrusion 226 respectively provide inlets and outlets for the fuel, oxidant and coolant flow fields 30, 32, 20. Referring to FIG. 4, first, second, third and fourth manifolds 44, 46, 48, 50 are arranged on first, second, third and fourth sides 86, 88, 90, 92 of the cell stack assembly 12, which typically includes six sides. Sealant 42 is arranged over the perimeter surfaces 114, 116, 118, 126 to seal the joints 39 along their length 41 (best shown in FIG. 3). Said another way, the sealant covers the perimeter surfaces 114, 116, 118, 26 and extends to the perimeter of each of the sides 86, 88, 90, 92 to encapsulate each of them. Sealant 42 on each of the sides 86, 88, 90, 92 may overlap the sealant 42 on the adjacent sides to ensure the joints 39 are entirely sealed. The sealant 42 is allowed to at least partially cure on one side before applying the sealant 42 to the next side. In this manner, the sealant 42 encapsulates the joints 39 to prevent fuel and oxidant in their respective fuel and oxidant flow fields 30, 32 from undesirably co-mingling by bypassing the electrode assembly 16. The sealant 42 may be a polyurethane, epoxy, silicone (RTV, for example) or any other suitable material that is a liquid in an uncured state, for example.

In one example, the first side 86 with its first manifold 44 provides a fuel inlet 52 to one anode protrusion 214. Fuel from fuel source 22 flows through the fuel flow fields of the anodes 14 and exits a fuel outlet 54 through the second manifold 46 that communicates with another anode protrusion 214 on second side 88. The third side 90 provides an oxidant inlet 56 that communicates with a cathode protrusion 218. Oxidant from the oxidant source 24 flows through the cathodes and exits the fourth side 92 through an oxidant outlet 58 provided by another cathode protrusion 218. The fourth manifold 50 provides a coolant inlet 60 provided by coolant protrusion 226. The coolant flows from the coolant inlet 60 to a coolant outlet 62 provided by the third manifold 48.

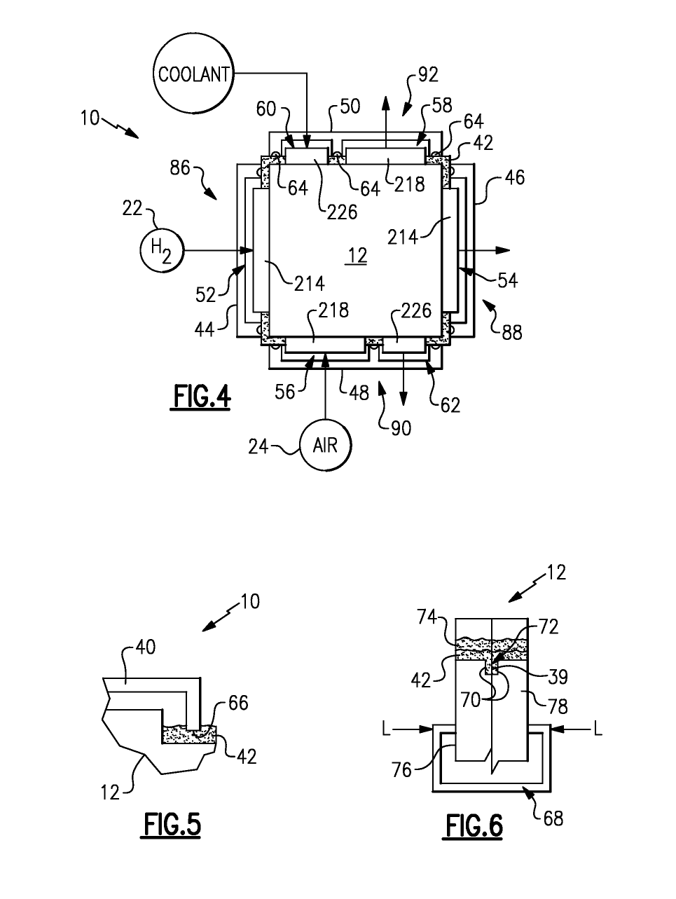

The manifolds 44, 46, 48, 50 are sealed relative to the sealant 42. In the example shown in FIG. 4, the manifolds include seals 64 that cooperate with the sealant 42 to provide a seal. In another example shown in FIG. 5, ends 66 of an example manifold 40 are embedded into the sealant 42, for example, while the sealant 42 has not yet cured to provide a seal between the manifold 40 and the cell stack assembly 12.

To ensure that the seal provided by the sealant 42 is not stressed excessively during operation of the fuel cell 10, a load device 68 (schematically shown in FIGS. 3 and 6) can be used to exert a load L on the cell stack assembly 12. With reference to FIG. 6, components 76, 78 of the cell stack assembly 12 may include recessed surfaces 70 to provide a gap 72. During application of the sealant 42 to the perimeter surfaces, the sealant 42 flows into the gap 72 thereby improving the seal between the cell stack assembly components 76, 78.

With continuing reference to FIG. 6, multiple sealants may be applied to the perimeter surfaces 114, 116, 118, 126. In one example, the sealant 42, which can be used as a primer, has a lower viscosity than a second sealant 74. The sealant 42 is applied to the cell stack assembly 12 first and is better able to flow and level than the second sealant 74, ensuring coverage of the joints 39. The second sealant 74 is then applied over the sealant 42 to provide additional sealing.

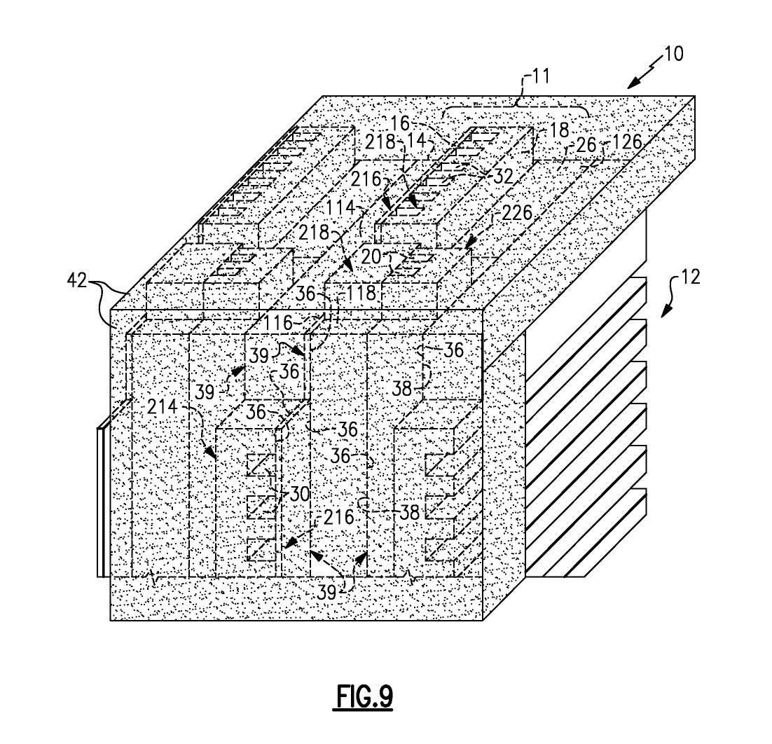

Referring to FIG. 7, the sealant 42 can be applied over the perimeter surfaces 114, 116, 118, 126 that are arranged in a staggered or offset relationship to one another to provide additional surface area to which the sealant 42 can adhere. In this manner, the seal provided across the cell stack assembly 12 is enhanced.

The electrode assembly 16 includes a membrane electrode assembly 80 that is arranged between gas diffusion layers 82, as shown in FIG. 8. The membrane electrode assembly 80 and gas diffusion layers 82 include electrode lateral surfaces 84 that are typically sealed relative to one another using polyethylene gaskets. These gaskets can be eliminated such that there are no interfacial seals provided between the electrode lateral surfaces 84. The electrode lateral surfaces 84 are in abutting engagement with one another. The sealant 42 that is applied over the perimeter surface 116 seals the membrane electrode assembly 80 and the gas diffusion layers 82 relative to one another.

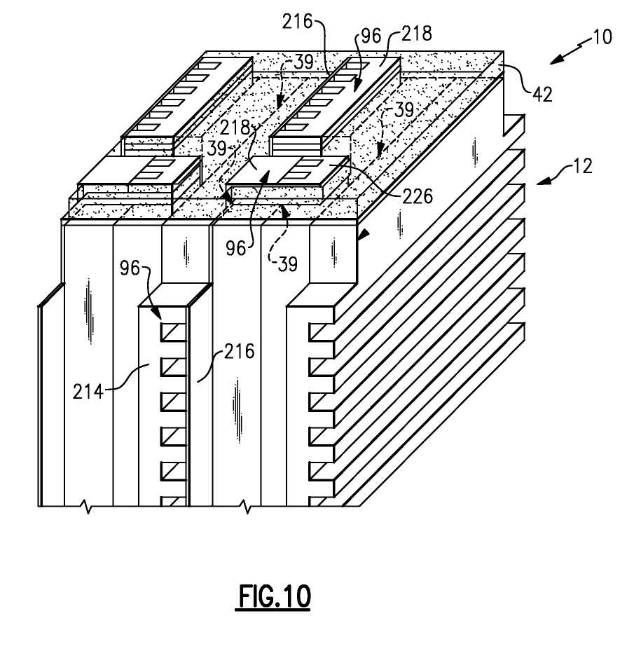

The cell stack assembly 12 can also be sealed by encapsulating one or more sides in sealant 42, as shown in FIG. 9. Specifically, the protrusions 214, 216, 218, 226 and perimeter surfaces 114, 116, 118, 126 are covered by sealant 42 in addition to the joints 39 and flow fields 20, 30, 32 being covered. Such an approach better ensures that all joints and crevices subject to possible leakage are sealed. The protrusions 214, 216, 218, 226 are then removed or machined, for example by a fly cut, to expose the flow fields 20, 30, 32, as shown in FIG. 10.

With the disclosed sealing arrangement, seal repairs can be made without disassembling the cell stack assembly.

Although example embodiments have been disclosed, a worker of ordinary skill in this art would recognize that certain modifications would come within the scope of the claims. For that reason, the following claims should be studied to determine their true scope and content.

What is claimed is:

1. A fuel cell comprising:
an electrode assembly arranged between a cathode and an anode, the electrode assembly, the anode and the cathode having lateral surfaces adjoining one another and respectively including fuel and oxidant flow fields, without any interfacial seals arranged between the lateral surfaces; and
a sealant applied to the anode, cathode and electrode assembly fluidly separating the fuel and oxidant flow fields.

2. The fuel cell according to claim 1, wherein the electrode assembly includes a membrane arranged between gas diffusion layers, the membrane and gas diffusion layers having electrode lateral surfaces adjoining one another, without any interfacial seals arranged between the electrode lateral surfaces, the sealant arranged over the membrane and gas diffusion layers.

3. The fuel cell according to claim 1, wherein the cathode, the anode and the electrode assembly provide joints at a perimeter of their adjoining lateral surfaces, the perimeter surrounding the fuel and oxidant flow fields, the sealant covering the joints.

4. The fuel cell according to claim 3, wherein the fuel cell includes six sides and the joints are provided on four sides of the six sides, the four sides encapsulated with the sealant to cover the joints.

5. The fuel cell according to claim 4, wherein the joints on the four sides are entirely encapsulated with the sealant.

6. The fuel cell according to claim 4, comprising a manifold in sealing engagement with the sealant at each of the four sides, the manifolds in fluid communication with the flow fields.

7. The fuel cell according to claim 6, wherein each manifold includes an end embedded in the sealant.

8. The fuel cell according to claim 3, wherein the cathode, the anode and the electrode assembly each include a perimeter surface at the perimeter that is transverse to the lateral surfaces, the sealant covering the perimeter surfaces.

9. The fuel cell according to claim 7, wherein at least one perimeter surface is offset from an adjoining perimeter surface.

10. The fuel cell according to claim 3, wherein the joints include a length, the sealant covering the entire length of the joints.

11. The fuel cell according to claim 2, wherein adjoining electrode lateral surfaces are in abutting engagement with one another.

12. The fuel cell according to claim 1, wherein adjoining lateral surfaces are in abutting engagement with one another.

13. A method of sealing a fuel cell stack assembly comprising the steps of:
arranging lateral surfaces of an electrode assembly in abutting engagement with lateral surfaces of an anode and cathode; and
applying a sealant to perimeter surfaces of the anode, cathode and electrode assembly that surround the lateral surfaces.

14. The method according to claim 13, wherein the sealant is a liquid in an uncured state, and the liquid sealant is applied to the perimeter surfaces.

15. The method according to claim 14, comprising the step of embedding an end of a manifold into the sealant before the sealant is fully cured.

16. The method according to claim 13, comprising the step of applying a second sealant over the sealant.

17. The method according to claim 13, wherein protrusions extend from the perimeter surfaces beyond the sealant, providing fluid communication with flow fields.

18. The method according to claim 13, comprising the steps of:
removing a portion of the sealant with the lateral surfaces maintained in abutting engagement with one another; and
applying sealant to the portion to reseal the perimeter surface.

19. The method according to claim 13, wherein the applying step includes encapsulating a side of the cell stack assembly with the sealant.

20. The method according to claim 19, comprising the step of removing a portion of the sealant to expose a flow field previously covered with sealant during the applying step.
